(19) United States
(12) Patent Application Publication
(10) Pub. No.: US 2003/0197892 A1
(43) Pub. Date: Oct. 23, 2003

(54) Print server apparatus and network print system

(76) Inventor: Chohiko Fukuoh, Tokyo (JP)

Correspondence Address: CANTOR COLBURN LLP, 55 Griffin Road South, Bloomfield, CT, 06002, US

(21) Appl. No.: 10/418,504

(22) Filed: Apr. 17, 2003

(30) Foreign Application Priority Data
Apr. 22, 2002 (JP) JP2002-119622

(51) Int. Cl. G06F 15/00; B41F 1/00

(52) U.S. Cl. 358/1.15

(57) ABSTRACT

The present invention relates to a print server apparatus for acquiring a print job relating to a print data file to be printed from outside via a network, and for conducting an outputting process based on the print job. The print server apparatus comprising: a print job acquiring section to acquire the print job from outside via the network and to acquire the print data file corresponding to the print job; a file format identifying section to identify a data form of the print data file corresponding to the print job; a data form converting section to convert the data form of the print data file into a data form of an image data for conducting a printing process, and a image forming section to form an image based on the image data and to output the image onto a recording material.

### TECHNICAL FIELD

The present invention relates to a print server apparatus and a network print system. In particular, the present invention relates to a print server apparatus having a printer server function and having a multiple printing function as, for example, a printer, a copying machine, a facsimile machine, and to a network print system to transmit a print job to the print server apparatus by the use of a network for outputting.

### TECHNICAL BACKGROUND

Nowadays, a plurality of communication terminal equipment such as personal computers (hereinafter referred to as “PC”), for example, are connected with the same network to share one image forming apparatus (for example, a printer) so that the image forming apparatus may be used as a common output apparatus by a plurality of communication terminal equipment. Such network print systems with various structures have been proposed (for example, Japanese UnExamined Patent Publication (JP-A) No. H06-059951, JP-A Nos. 2000-298568 and 2001-265555).

In the network print system of this kind, a sending client who transmits a print job, for example, acquires print data file from a file server on the network. Then, the sending client prepares the print job by subjecting the print data file to an appropriate print condition configuration, and transmits the print job to a print server or an image forming apparatus having print server functions in a receiving client. Subsequently, the printing device in the print server or the image forming apparatus carries out printing.

However, there have been following problems in conventional network print systems.

1) When a sending client transmits a print job, it is sometimes necessary to specify a data form relating to a print data file, namely to specify an application software with which the print data file was prepared. Further, it is necessary to convert the data form of the print data file into a data form, which can be recognized by an image forming apparatus. Thus, the sending client is requested to conduct complicated condition configuration, and it is difficult to construct those, which can be operated easily.

2) A sending client is required to have a tools such as a device driver (printer driver) relating to print processing and an application software, which are needed when a print data file is subjected to printing process. Therefore, the sending client is required to conduct managements such as upgrading for the tools, even if the tools are intended to perform only print processing. Further, a storage device, for example PC, having a greater storage capacity is required. Thus, burdens including a cost aspect imposed on the sending client are heavy.

Further, with progress of network technology in recent years, opportunities to use an E-mail are increasing, and sending and receiving of E-mail are conducted by attaching on the E-mail a data file prepared by a certain application software.

However, when a receiving client who received the Email does not have the application software relating to the file attached on the E-mail, the receiving client cannot confirm contents of the attached file.

3) There exist not a few occasions wherein information on a display screen on a communication terminal equipment of a mobile type, for example a cellphone, is requested to be outputted by an image forming apparatus, even if the communication terminal equipment does not have functions for requesting print processing.

However, most of the terminal equipments of the mobile type are those of a battery-powered type. Since the terminal equipments consume much power when they transmit or receive print data file itself, as the result, the terminal equipments are required to be provided with a huge battery or to be charged frequently. That results in reducing functions as a mobile type terminal equipment, and causes troubles when other functions are used to lower the conveniences on the contrary.

### SUMMARY OF THE INVENTION

The invention has been achieved in view of the situations stated above.

A first aspect of the invention is to provide a print server apparatus and a network print system, which can perform desired printing process surely without establishing complicated print condition configuration.

A second aspect of the invention is to provide a print server apparatus and a network print system, which can perform desired printing process surely, even when a sending client and a receiving client relating to a print job do not have an application software and a device driver, which are necessary when a print data file is subjected to printing process.

A third aspect of the invention is to provide a print server apparatus and a network print system, which can perform desired printing process surely by utilizing a communication terminal equipment having a certain Web browser function and having no function for requesting printing process.

One embodiment of the present invention is a print server apparatus for acquiring a print job relating to a print data file to be subjected to print processing from outside of the apparatus via a network and for conducting outputting process for the print job. The print server may have therein a print job acquiring section to acquire a print job from the outside via a network, a file format identifying section to identify a data form of a print data file relating to the print job, a data form converting section to convert the data form of the print data file into a data form of an image data for conducting printing process and an image forming section to form an image based on the image data and to output the image on a recording material.

In the print server apparatus of the invention, when the print job does not comprise the print data file itself but comprises file specifying information to show a whereabouts of the print data file, it is preferable that the print job-acquiring section is capable of loading a specified print data file based on file specifying information.

Further, it is preferable that the print job-acquiring section is capable of supplying a print job-forming Web data for forming a print job including file specifying information that shows a whereabouts of the print data file in response to a requirement from outside, and the print job-acquiring section is capable of loading a print data file specified by the file specifying information in the print job formed by the print job-forming Web data.

Further, it is preferable that the print job-acquiring section is capable of conducting data communication by Internet protocol prescribed in RFC 821, RFC 959, RFC 2228, RFC 2616 and RFC 2911.

Another embodiment of the present invention is a network print system of the invention can be comprised of:

the above-described print server apparatus owned by a receiving client, the print server apparatus receiving a print job from outside through a network;

one or plural communication terminal equipment owned by a sending client, the print job being transmitted from the communication terminal equipment via the network; and

a data server in which a print data file relating to the print job can be stored,

wherein the print server apparatus, the communication terminal equipment and the data server are connected to the same network.

Further, it is preferable that an application software relating to the print data file and a device driver for controlling the state of operations of the print server apparatus are stored in the data server.

In the network print system of the invention, printing process shown in each of the following (1)-(4) items can be conducted.

[1] When a print job transmitted from a communication terminal equipment of a sending client includes a print data file itself, the print server apparatus, which has received the print job, identifies a data form of the print data file in the print job by a file format-identifying section. Subsequently, the data form of the print data file is converted, by a data form-converting section, into a data form of an image data for printing process for conducting printing process, and then, an image forming section forms images based on image data for printing process and outputs the images on a recording material.

[2] When the print job transmitted from the communication terminal equipment of the sending client does not include the print data file itself, but includes file specifying information showing a whereabouts of the print data file, and when the print server apparatus of the receiving client is capable of acquiring the specified print data file based on the file specifying information, the print server apparatus, which has received the print job, acquires the specified print data file from the data server based on the file specifying information by a print job-acquiring section. Subsequently, the data form of the print data file is identified by a file format-identifying section, and then, the data form of the print data file is converted, by a data form-converting section, into a data form of an image data for printing process for conducting printing process. Then, the image forming section forms images based on the image data for printing process, and outputs the images on a recording material.

[3] When the print server apparatus owned by the receiving client is capable of supplying a print job-forming Web data for forming a print job including file specification information and capable of acquiring a print data file based on the file specifying information, and when the print job is transmitted with utilizing the print job-forming Web data from a communication terminal equipment, which is owned by a sending client and has Web browser function but has no function to require the print server apparatus to conduct print processing, the print server apparatus that has received the print job acquires the specified print data file based on file specifying information from the data server by a print job acquiring section. Subsequently, the print server identifies a data form of the acquired print data file with a file format identifying section, and then, converts a data form of the print data file into a data form relating to image data for printing process with a data form converting section. Subsequently, the print server forms images based on image data for printing process and outputs the images on a recording material. In this case, it is possible to use one selected from a cellphone, a TV set, car navigation and a game machine, as the communication terminal equipment on the part of the sending client. Further, the print job-forming Web data may be stored in the data server, and be utilized by the communication terminal equipment to make the print job.

[4] When the data server has a mail server function for conducting sending and receiving of E-mails, and when print job, which includes a print data file and is attached with an E-mail, is transmitted to the print server apparatus by the receiving client and the print data file is output by the print server apparatus, the print server apparatus that has received the print job identifies a data form of the print data file in the print job with a file format identifying section. Subsequently, the print server apparatus converts a data form of the print data file into a data form relating to the image data for printing process with a data form converting section, and then, forms images with an image forming section based on the image data for printing process and outputs the images on a recording material.

In the network print system of the invention, when the data form of the print data file relating to the print job is converted, it is preferable that in case the data form identified by the file format identifying section is a data form depending on an application software, the data form of the print data file is converted into the data form of a page description language applicable to the print server apparatus, and then, is converted into the data form of the image data for printing process.

In this case, the converting processing for the acquired print data file into the data form composed of the page description language of the print server apparatus can employ an arrangement wherein the application software relating to the print data file in a data server is started and the converting process is conducted by using a data form converting function in the application software.

(Effect)

In the print server apparatus having the aforesaid structure, complicated configuring operation such as specification of the data form of the print data file which has been required in the conventional technology when transmitting the print job to the print server apparatus is not needed because of the provided function to identify automatically the data form of the print data file in the acquired print job. Therefore, it is possible to construct the print server apparatus as one, which can be operated easily and is convenient.

Further, it is not necessary to transfer the print data file itself to the print server apparatus, because the print job acquiring section is capable of acquiring the specified print data file based on file specifying information that indicates a whereabouts of the print data file. Therefore, an amount of power consumption needed for transferring the print job can be small, and thereby, it is possible to use a terminal equipment of a mobile type having a small memory capacity and a small disk capacity to make it to conduct desired printing process surely.

Since the sending client can transmit the print job to the print server apparatus by utilizing the print job-forming Web data, which is supplied by the print job acquiring section or is stored in the data server, desired printing process can be conducted by utilizing a Web browser function owned by a communication terminal equipment, even when the communication terminal equipment itself does not have a function to require the print server apparatus to conduct printing process.

In the network print system having the aforesaid construction, printing process can be carried out without conducting complicated configuring operations because of the aforesaid print server apparatus provided in the network print system. Therefore, it is possible to obtain easy operations and conveniences, and a degree of freedom for selecting a communication terminal equipment for making the print server apparatus to conduct printing process turns out to be high, thus, even a user utilizing communication terminal equipment other than a personal computer can conduct printing process, which attains extension of a printing market.

Further, by arranging an application software relating to a print data file and a device driver of the print server apparatus to be owned by a data server to be shared by a plurality of clients, it is not necessary for the sending client and receiving client to own the application software and the device driver, burdens for management such as upgrading and burdens in terms of cost can be reduced.

### BRIEF DESCRIPTION OF THE DRAWINGS

FIG. 1 is a block diagram showing a schematic structure of an example of a network print system of the invention.

FIG. 2 is a flow chart showing processing procedures of print processing conducted in a print server apparatus of the invention.

FIG. 3 is an illustration showing an example of a setup screen for print job-forming Web data used for transmitting a print job to a print server apparatus when conducting print processing by using a Web server function in the print server apparatus.

FIG. 4 is a flow chart showing another example of processing procedures of printing process conducted in a print server apparatus of the invention.

### PREFERRED EMBODIMENTS OF THE PRESENT INVENTION

Preferred embodiments of the invention will be explained as follows.

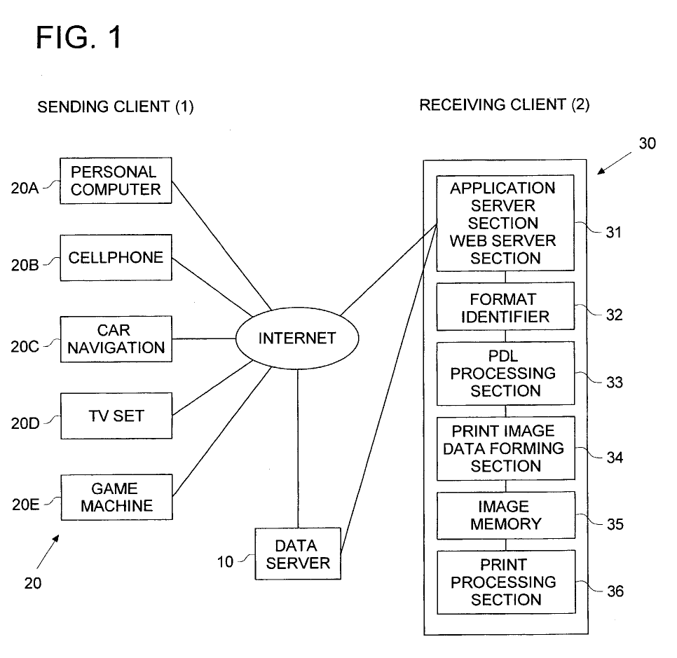

FIG. 1 is a block diagram showing a schematic structure in an example of a network print system of the invention.

The network print systems is composed of sending client (1), receiving client (2) and data server 10, which are connected by a common network each other. As an example, the structure to output a print job to print server apparatus 30 of the receiving client (2) from communication terminal equipment 20 of the sending client (1). In this case, the sending client (1) and the receiving client (2) may be in the relation either of the remote positions or of the local positions.

For the communication terminal equipment 20 of the sending client (1) conducting request for output of print job, the communication terminal equipment itself does not need to be one having a function for configuring print operations, such as a device driver, to conduct operation control of print server apparatus 30, and it is only necessary to have an appropriate Web browser function for utilizing Web data on the network. As communication terminal equipment 20 of this kind, there may be exemplified, personal computer 20A, cellphone 20B, car navigation equipment 20C, TV set 20D and game machine 20E.

Print server apparatus 30 in receiving client (2), which receives request for output of print job, may be an apparatus, which has a function as a print server, such as a printer, a copying machine, a facsimile machine and an image forming apparatus wherein the above-mentioned functions are compounded. In a concrete form, it is provided, as shown in FIG. 1, with application server section/Web server section (print job-acquiring section) 31 that acquires print data file that is subjected to printing process when a print job from sending client (1) is received, data format identifying section 32 that identifies automatically a data form of the acquired print data file, PDL processing section (data form-converting section) 33 that converts the data form of the print data file identified by format discriminating section 32 into a data form of a page description language in print server apparatus 30, print image data forming section (data form converting section) 34 that converts the data file converted by PDL processing section 33 into image data for printing process, image memory 35 that stores therein the image data for printing process formed by the print image data forming section 34 and print processing section (image forming section) 36 that forms images based on image data for printing process stored in the image memory 35 and outputs the image onto a recording material such as transfer paper.

(Application Server Section/Web Server Section)

As above described, the application server section/Web server section 31 has the so-called print server function to receive print job from the sending client (1) through the network and to acquire print data file relating to the print job from communication terminal equipment 20 of sending client (1) or from data server 10.

Further, it is preferable that the application server section/Web server section 31 has therein a function to display the status of the print server apparatus 30, a function to monitor the state of processing of print job, an interruption function to change the order of process depending on precedence of the print jobs, and a function to stop printing process based on an instruction from sending client (1).

It is preferable that the application server section/Web server section 31 can be corresponding to various communication protocols which are used presently, and it is specifically structured to be capable of conducting data communication by utilizing, for example, RFC 821 (SMTP form relating to transmission and receiving of E-mail), RFC 959 (FTP form relating to file transfer), RFC 2228 (FTP form wherein security is strengthened), RFC 2616, RFC 2911, HTTP form relating to transmission and receiving of data file of HTML form and other TCP/IP (Transmission Control Protocol/Internet Protocol) form.

A print job transmitted from sending client (1) may include a print data file itself to be subjected to printing process or include a URI (Universal Resource Identifiers) specifying data file showing a whereabouts of the data file. The print job preferably includes a configuration of print condition such as print quantity, enlargement and reduction, and finishing-treatments such as staple processing, punch processing and bookbinding.

(Format Identifying Section)

The format identifying section 32 has a function to identify automatically a data form (that depends on the application software by which the data file was prepared) of a print data file relating to the print job acquired by application server section/Web server section 31. It specifically is composed, for example, of CPU operated by the program for identifying a data form and of an exclusive circuit housing therein logic for identifying a data form.

(PDL Processing Section)

The PDL processing section 33 has a function to conduct primary converting process for converting the image data form relating to the application software (hereinafter referred to as “application form”), which is the data form of the print data file identified by the format identifying section, into a data form (hereinafter referred to as “PDL form”) composed of page description language (PDL: page-description language) in print server apparatus 30. In concrete terms, the PDL processing section 33 has a function to start up the application software relating to the print data file of the application form and to convert into the PDL form that can be recognized by print server apparatus 30 by utilizing a data form converting function by the application software.

Further, when there is no interchangeability directly between the application form relating to the application software and the PDL form capable of being recognized by the print server apparatus 30, the PDL processing section 33 preferably has a function to convert temporarily the print data file of the application form into the data file having an intermediate data form which is between the application form and the PDL form and is interchangeable with the PDL form, and to convert finally into the data file of the PDL form.

The primary converting processing by PDL processing section 33 is conducted for the print data file having the application form. Therefore, when the acquired print data file, for example, is one transmitted from sending client (1) by utilizing a device driver (printer driver) applicable to the print server apparatus 30, this print data file is to be subjected to secondary converting processing by print image data forming section 34 which will be described later, because the acquired data file is one having a PDL form subjected to PDL processing by a printer driver.

(Print Image Data Forming Section)

The print image data forming section 34 has a function to conduct secondary converting process for converting the data form of the received data file, which has been subjected to the primary converting process to be of a PDL form by the PDL processing section 33, into the data form (hereinafter referred to as “print image form”) relating to the image data for printing process for conducting printing process by print server apparatus 30.

In the network print system of the invention, data server 10 may be utilized. The data server 10 has a function as a file server, and is capable of receiving a data file prepared by sending client (1) through a network and storing it, is capable of transferring the specified data file in response to the request for transmission of the print data file from the sending client (1) or receiving client (2). The data server 10 may be owned by the sending client (1) or by the third party other than both the sending client (1) and the receiving client (2).

The data server 10 may have, for example, various application softwares with which the sending client (1) prepares data file and a device driver (printer driver) for conducting operation control for print server apparatus 30 of receiving client (2), in addition to the print data file. The data server 10 can be provided with the so-called application server function to start an application software relating to print data file and to convert into the PDL form in response to the request for converting data form from receiving client (2), and to transfer the print data file converted into of a PDL form to print server apparatus 30 of receiving client (2).

Further, the data server 10 may also be composed of the so-called function-combined server equipped with a Web-server function providing Web data on the Internet, a mail server function for conducting transmission and receiving of E-mail and other server functions.

Still Further, in the aforesaid network print system, it is also possible to arrange so that the data server 10 is structured to have only a file server function and an application server function, and an exclusive server having functions other than the aforesaid functions is used separately.

Processing procedures of printing process conducted in the aforesaid network print system will be explained as follows.

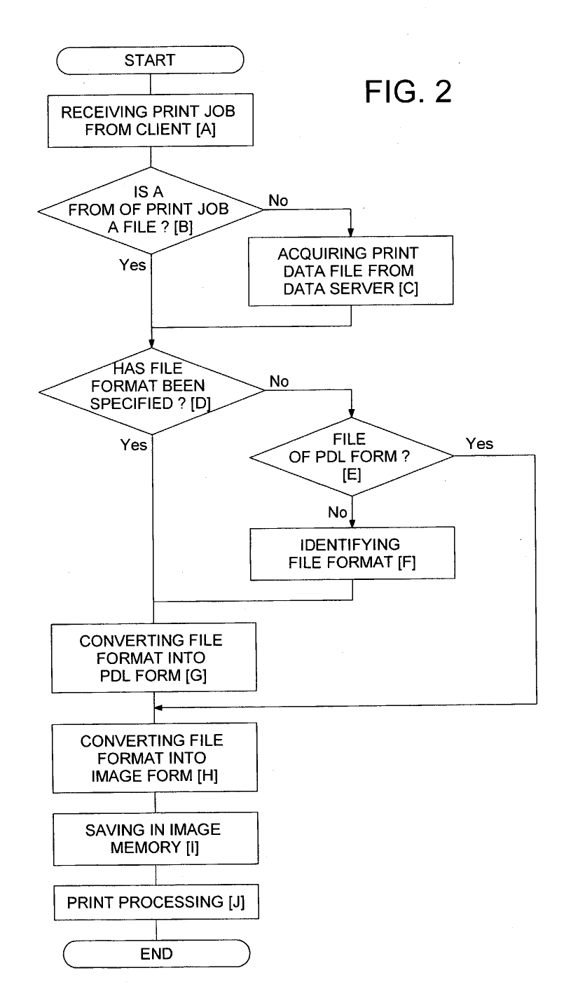

In this network print system, when a print job prepared by sending client (1), for example, is transmitted to print server apparatus 30 of receiving client (2) through the Internet, the print job is received by application server section/Web server section 31 (A) as shown in FIG. 2, and is stored in a file server (not shown) in the receiving client (2), and then, printing process is carried out.

Namely, the application server section/Web server section 31 conducts firstly the print job judgment process for judging whether the received print job includes print data file itself prepared by an appropriate application software, or includes URI specification data file (also referred to as a file specifying information) showing a whereabouts of the print data file (B). As a specific judgment method, there is used, for example, a method to judge identification information relating to the data form included in the print job.

Then, in case the print job is recognized to include URI specification data file, the data server 10 is accessed by the application server section/Web server section 31 based on URI specification information, and print data file acquiring process for acquiring specified print data file is conducted (C).

On the other hand, in case the print job is recognized to include the print data file itself, format identifying section 32 conducts, in print condition configuring operations conducted when the print data file is transmitted from sending client (1), format specification presence judgment process that judges whether the data form about the print data file, namely, the application software used when preparing the print data file was specified or not (D). A specific judgment method is conducted by judging, for example, identification information (format specifier) established in response to each of application software. Even when a data form of the print data file is not specified, some format specifier or other, for example, is attached.

Then, when it is confirmed that the data form of the print data file has not been specified, firstly, the data form judgment process is conducted for judging whether the print data file is transmitted by using a printer driver of print server apparatus 30 or not, namely, whether the data form of the print data file is a PDL form or not (E). To be concrete, since the print data file transmitted by utilizing the printer driver includes the identification information for identifying that PDL processing has been conducted by the printer driver, judgment of this identification information makes it possible to identify whether the print data file is of the application form or of the PDL form.

When a data form of the print data file is not specified, and when it is confirmed that this print data file is not of the PDL form, format identifying process that identifying a data form of the print data file is conducted (F). To be concrete, the data form of the print data file is identified by (a) confirming an expander attached to the acquired print data file, (b) confirming a identification mark of the file preparation application software included in resource data constituting the print data file, (c) confirming an arrangement form of data constituting the print data file, and by (d) comparing specific data form included in the print data file (for example, ASCII data and numerical values) with those established in advance corresponding to each application data file.

In format specification presence judgment process (D), primary converting process (PDL processing) that converts a data form from an application form into a PDL form is conducted as occasion demands, for the print data file of which the specification of the data form has been confirmed and the print data file of which the application software for preparation has been recognized by format discrimination section 33 (G). In this case, the reason for “as occasion demands” is as follows. When there is interchangeability between the application software by which the print data file is formed and device driver of the print server apparatus 30, the print data file does not need to be subjected to the primary converting process by PDL processing section 33, but is subjected to secondary converting process (H) by print image data forming section 34.

Specifically, PDL processing is conducted, by accessing a data server through application server section/Web server section 31, then, by starting the application software relating to the print data file, and thereby by utilizing a data converting function of the application software, or by making the PDL processing section 33 to possess a file converting application software in advance, and by starting the file converting application software. When receiving client (2) owns the application software relating to the data file, in this case, what is usually used is not the application software owned by the data server (remote one) but is the application software owned by the receiving client (local one).

Further, it is possible to build construction wherein, when conducting the converting process for the data form of the print data file, the data form is converted temporarily into an intermediate data form between an application form and a PDL form, namely into a data form capable of being recognized by both of the application software and print server apparatus 30, and then, this intermediate data form is converted into the PDL form.

Then, secondary converting process that converts the data form from a PDL form into a print image form is conducted (H) for the print data file judged to have a PDL form by data form judgment process (E) of format identifying section 32 and for the print data file converted by the primary converting process of PDL processing section 33 from the application form into the PDL form.

Then, image data for printing process acquired by converting into a print image form are stored in image memory 35 (I), and then, images are formed by print processing section 36 based on the image data for print processing, to be outputted on a recording material such as, for example, a transfer sheet (J).

Next, print processing that can be conducted by the network print system of the invention will be explained as follows in a concrete form.

[1] When sending client (1) transmits a print job including a print data file itself to a print server apparatus of receiving client (2) directly for outputting through the Internet, by using PC as communication terminal equipment 20 (under the assumption that the sending client (1) and the receiving client (2) are in the relationship of remoteness each other);

In this case, the sending client (1) sends a request for transmission of a print data file to be outputted by print server apparatus 30 and of a device driver relating to print server apparatus 30 to the data server 10, and after acquiring them, the sending client conducts configuring of a series of print conditions including information of a data form about a print data file, such as, for example, a print range, print quantity and density setting by utilizing the acquired device driver, and thereby, prepares a print job and transmits the print job to print server apparatus 30 of the receiving client (2). In this case, it is not always essential for the sending client (1) to specify the data form about the print data file when it establishes print conditions.

After the print job is received by print server apparatus 30 of receiving client (2), print job judgment process by application server section/Web server section 31 is conducted, thereby, the data file relating to the print job is confirmed to be the print data file itself (B), and then, format specification presence judgment process is conducted, and both the data form judgment processing and format identification process are conducted appropriately by format identification section 32, thus, the application software used for forming the print data file is automatically identified (D, E and F).

Next, after the print data file is converted from the application form into the PDL form (G) by primary converting process conducted by PDL processing section 33 as occasion demands, the print data file is converted finally from the PDL form into print image form (H) by secondary converting processing conducted by print image data forming section 34, and after the image data for print processing formed by secondary converting processing are stored in image memory 35, and then, images are formed by print processing section 36 based on image data for print processing to be outputted on a recording material.

In the case of conducting the print processing stated above, print server apparatus 30 of the invention having the function to identify automatically the data form of the print data file relating to the received print job, makes it possible to conduct print processing without conducting complicated configuring operations such as, for example, operations for specification of data form of the print data file, which were required in the conventional technology when transmitting a print job to print server apparatus 30, thus, it is possible to obtain easy operations and conveniences.

Therefore, the network print system of the invention can lighten basically the burdens for sending client (1) in transmission of print data file from communication terminal equipment 20.

Further, when an application software relating to the print data file and a device driver of print server apparatus 30 are owned by data server 10 to be shared by a plurality of clients, it is not necessary for sending client (1) and receiving client (2) for the print job to possess the application software and the device driver, and thereby, burdens in terms of management such as upgrading, for example, and burdens in terms of cost which are imposed on the sending client (1) and the receiving client (2) can be reduced.

[2] When sending client (1) is not a print data file itself in the aforesaid item [1], and when the print job including URI specification data file that shows a whereabouts of the print data file is transmitted to print server apparatus 30 to make it to output the print data file relating to the print job;

In this case, the sending client (1) sends a request for transmission of a device driver relating to print server apparatus 30 to data server 10, and after acquiring it, the sending client conducts configuring of a series of print conditions including information of a data form about a print data file, such as, for example, a print range print quantity and density setting, by utilizing the acquired device driver, and thereby, prepares a print job including URI specifying data file showing a whereabouts of the print data file to transmit the print job to print server apparatus 30 of the receiving client (2).

After the print job is received by print server apparatus 30 of receiving client (2), the print job is confirmed by application server section/Web server section 31 to include URI specification data (B), and then, the specified print data file is acquired from data server 10 based on the acquired URI specification information (C), and an application software for the print data file is automatically identified by format identifying section 32 (D<E and F). In this case, the print data file acquired from data server 10 is of the application form.

Next, after the primary converting processing by PDL processing section 33 is conducted for the print data file (G), image data for print processing are formed by secondary converting processing conducted by print image data forming section 34 (H), and after the image data for print processing are stored in image memory 35, images are formed by print processing section 36 based on image data for print processing and are outputted on a recording material.

In the case of conducting the print processing stated above, application server section/Web server section 31 has a function to acquire the specified print data file based on URI specification information that shows a whereabouts of the print data file, in the print server apparatus 30 of the invention, thus, it is unnecessary to transmit the print data file itself, and power consumption needed by transfer of a print job can be less, which makes it possible to carry out desired printing process surely by utilizing a terminal equipment of a mobile type whose memory capacity and disk capacity are small.

In the network print system of the invention, therefore, only transmission of URI specification information to print server apparatus 30 can make the print server apparatus 30 to conduct printing process, and therefore, the print job for the print server apparatus 30 can be issued promptly. Thus, even when the print processing is required to be conducted for the print data file having a large data capacity, for example, sending client (1) that transmits a print job is hardly affected by, for example, data communication wherein other operations are interrupted, and high working efficiency is obtained.

When sending client (1) transmits a print job including a URI specification data file showing a whereabouts of the print data file to print server apparatus 30 of receiving client (2) from the location where it is staying by the use of a cellphone capable of utilizing an appropriate Web browser as communication terminal equipment 20, to make the print server apparatus 30 to output the print data file relating to the print job;

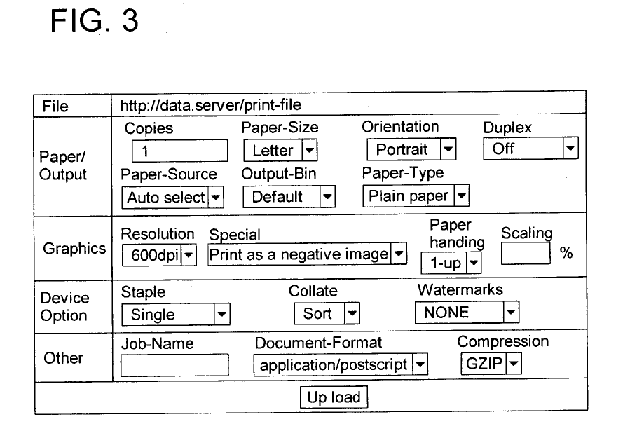

In this case, the sending client (1) accesses print server apparatus 30 by utilizing a Web browser function of the cellphone, and acquires print job forming Web data (device driver) as shown in FIG. 3, for example, from application server section/Web server section 31 or from the data server 10, and then, prepares a print job including URI specification data file showing a whereabouts of the print data file by conducting establishment of a series of print conditions by using the acquired device driver, and transmits this print job to print server apparatus 30 of receiving client (2).

As items of configuring print conditions in a device driver provided by print server apparatus 30 or by the data server 10, there are given setting of a print data file and URI showing a whereabouts of the print data file [File], for example, setting of sheets to be used and parameters related to other output [Paper/Output], setting related to graphics such as, for example, resolution and magnification [Graphics], setting related to finishing processing such as, for example, sorting processing and staple processing [Device Option] and setting of a format, for example, of a name of a print job and of a print data file [Other].

When a print job is received by print server apparatus 30 of receiving client (2), print job judgment process (B) by application server section/Web server section 31 and print data file acquiring process (C) are conducted in the same way as in the above item [2], then, format specification presence judgment process (D) is conducted by format identifying section 32 for print data file acquired from data server 10, and both data form judgment process (E) and format identifying process (F) are conducted properly, and then, secondary converting process by the print image data forming section 34 is conducted (H) after the primary converting process by PDL processing section 33 is conducted as occasion demands, thus, image data for printing process are formed, and images are formed by print processing section 36 based on image data for printing process to be outputted on a recording material, after the image data for printing process are stored in image memory 35.

In the case of conducting printing process as in the foregoing, print server apparatus 30 of the invention can issue the print job by using print job forming Web data supplied by application server section/Web server section 31 or obtained from the data server 10, which makes a degree of freedom for selection of communication terminal equipment 20 to be high, thus, it is possible to conduct the desired print processing surely by using, for example, a cellphone, a TV set, a car navigation apparatus and a game machine wherein a function to make print server apparatus 30 to conduct print processing is not owned by communication terminal equipment 20.

Therefore, in the network print system of the invention, even when sending client (1) is a user other than PC user, it is possible to conduct the desired printing process by utilizing communication terminal equipment 20 capable of using an appropriate Web browser function, which expands a market of printing.

Further, even when a user in receiving client (2) is requested, at a location where the user is staying, to output the data file which was made by that user, the user can use communication terminal equipment 20 such as a cellphone from the location where the user is staying to make it to conduct printing process, which is extremely useful.

When making print server apparatus 30 of receiving client (2) to output information displayed on a display screen of a communication terminal equipment capable of utilizing an appropriate Web browser such as a TV set, a car navigation apparatus or a game machine;

In this case, sending client (1) utilizes a Web browser function in these communication terminal equipment 20 to acquire print job forming Web data (device driver) from application server section/Web server section 31 or from the data server 10 and to conduct configuring of a series of print conditions by using the acquired device driver, and thereby, it prepares a print job including URI specification data file showing a whereabouts of the print data file to transmit it to print server apparatus 30 of receiving client (2).

When a print job is received by print server apparatus 30 of receiving client (2), print job judgment process (B) by application server section/Web server section 31 and print data file acquiring process (C) are conducted, then, format specification presence judgment process (D) is conducted by format identifying section 32 for print data file acquired from data server 10, and both data form judgment process (E) and format identifying process (F) are conducted properly, and then, secondary converting process by print image data forming section 34 is conducted (H) after the primary converting process by PDL processing section 33 is conducted as occasion demands, thus, image data for printing process are formed, and images are formed by print processing section 36 based on image data for printing process and are outputted on a recording material, after the image data for print processing are stored in image memory 35.

In the case of conducting print processing as in the foregoing, the sending client (1) can issue a print job by utilizing print job forming Web data supplied by the application server section/Web server section 31. It is therefore possible to conduct printing process even for text information, for example, on the display screen of those wherein communication terminal equipment 20 itself has no function to make others to conduct printing process for which the printing process has not been conducted in the past.

Therefore, the network print system of the invention makes it possible to obtain information in Web data on the Internet, for example, as a document, and it is possible to construct as one satisfying demands of users for the communication terminal equipment as stated above.

When an application data file (hereinafter referred to as “attached file”) attached to E-mail that is transmitted from sending client (1) is outputted by print server apparatus 30 (under the assumption that receiving client (2) itself has no application software relating to the attached file);

In this case, a print job is prepared when a series of print conditions about the attached file are established by receiving client (2) itself, and after this print job is transmitted to application server section/Web server section 31 of print server apparatus 30, the received attached file is transferred to format identifying section 32 which, thereafter, conducts format specification presence judgment process (D), data form judgment process (E) and format identifying process (F). Then, after the primary converting process by PDL processing section 33 is conducted for this print data file as occasion demands, secondary converting process is conducted by print image data forming section 34 (H) and thereby, image data for printing process are formed, and after the image data for printing process are stored in image memory 35, images are formed by print processing section 36 based on the image data for printing process, to be outputted on a recording material.

In the case of conducting printing process such as those aforementioned, print server apparatus 30 of the invention that has a function to start up an application software in data server 10 and to convert the data form of the attached file into a data file of a PDL form by using a data form converting function in the application software makes it possible to conduct printing process of the attached file, even when receiving client (2) that has received an E-mail does not have the application software relating to the attached file of the E-mail.

Therefore, in the network print system of the invention, sending client (1) can transmit an E-mail without considering whether receiving client (2) can recognize a data form of the attached file of the E-mail or not. Therefore, burdens imposed on the sending client (1) can be lightened, and the receiving client (2) can obtain contents of the attached file as a document, by making print server apparatus 30 to conduct printing process, independently of the application software with which the attached file of the E-mail was prepared, thus, and the application software, which the sending client (1) possess only for printing process, for example, is not necessary, which can reduce burdens for management of the application software and burdens in terms of cost.

There have been explained specific embodiments of the invention to which, however, the invention is not limited, and various modifications may be made.

For example, the number of sending clients each transmitting a print job to a print server apparatus is not restricted in particular.

Further, in the examples of the aforesaid items [1]-[5], sending client (1) and receiving client (2) are explained to be in the relationship of remote positions each other. However, it is also possible to employ an arrangement wherein both of the sending client and the receiving client are in the relationship of local positions each other, and an intranet, for example, is used as a communication means.

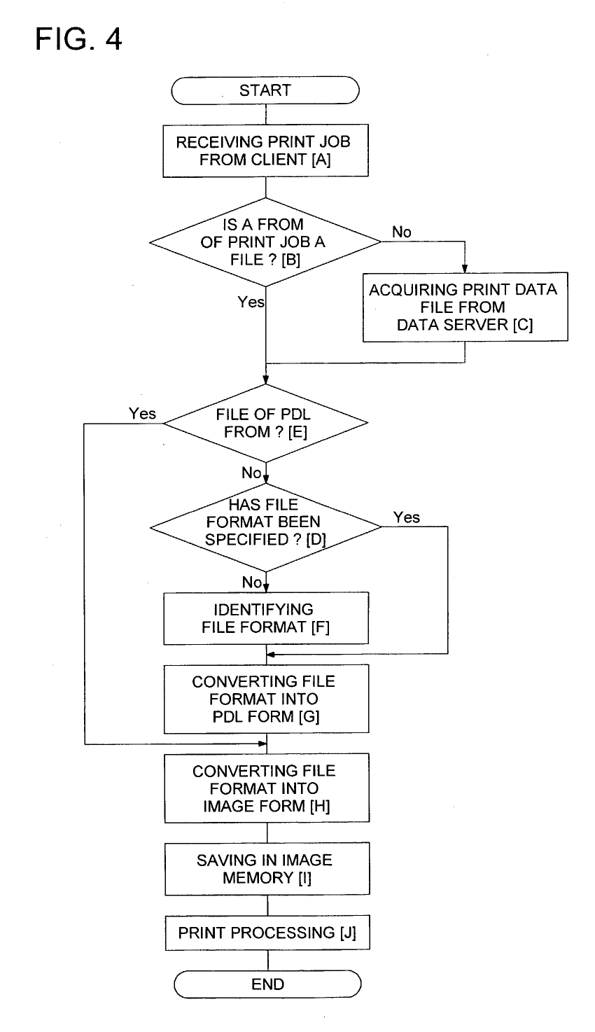

Further, in the print processing conducted in a print server apparatus, it is possible to control so that format specification presence judgment process (D) and format identifying process (F) may be conducted after data format judgment process (E) for judging a print data file obtained from the sending client (1) whether it is of a PDL form or not, as shown in FIG. 4 for example.

### Effects

In the print server apparatus of the invention, it is possible to conduct desired printing process surely without configuring complicated print conditions, and to conduct desired printing process surely under the condition that each of the sending client and the receiving client for the print job does not have an application software and a device driver needed for printing process of the print data file, and it is possible to conduct desired printing process surely by utilizing a communication terminal equipment, which has an appropriate Web browser function and does not have a function to make others to conduct printing process.

In the network print system of the invention, it is possible to conduct desired printing process surely without setting complicated print conditions, and to conduct desired printing process surely under the condition that each of the sending client and the receiving client for the print job does not have an application software and a device driver needed for printing process of the print data file, and it is possible to conduct desired printing process surely by utilizing a communication terminal equipment which has an appropriate Web browser function and does not have a function to make others to conduct printing process.

What is claimed is:

1. A print server apparatus for acquiring a print job relating to a print data file to be printed from outside via a network, and for conducting an outputting process based on the print job, comprising:
a print job acquiring section to acquire the print job via the network and to acquire the print data file corresponding to the print job;
a file format identifying section to identify a data form of the print data file corresponding to the print job;
a data form converting section to convert the data form of the print data file into a data form of an image data for conducting a printing process, and
a image forming section to form an image based on the image data and to output the image onto a recording material.

2. The print server apparatus of claim 1, wherein when the print job acquired by the print job acquiring section does not include the print data file, but includes a file specifying information to specify a whereabouts of the print data file, the print job acquiring section loads the print data file based on the file specifying information via the network.

3. The print server apparatus of claim 1, wherein the print job acquiring section is capable of supplying a print job forming Web data for forming the print job including a file specifying information to specify a whereabouts of the print data file in response to a request from outside, and is capable of loading the print data file corresponding to the print job based on the file specifying information via the network.

4. The print server apparatus of claim 1, wherein the print job acquiring section is capable of conducting a data communication by an Internet protocol defined in RFC 821, RFC 959, RFC 2228, RFC 2616 and RFC 2911.

5. The print server apparatus of claim 1, wherein the data form converting section comprises a PDL processing section to converting the data form of the print data file into a PDL form, and a print image data forming section to convert the PDL form into the data form of the image data.

6. A network print system comprising:
the print server apparatus of claim 1; and
a communication terminal equipment to send a print job to the print server apparatus via a network, the print server apparatus and the communication terminal equipment being connected via the network with each other,
wherein when the print job sent by the communication terminal equipment includes a print data file, the print server apparatus, which receives the print job, identifies a data form of the print data file by the file format identifying section, converts the identified data form of the print data file into a data form of an image data for conducting a printing process by the image forming section, forms an image based on the image data, and outputs the image onto a recording material by the image forming section.

7. A network print system comprising:
the print server apparatus of claim 2;
a communication terminal equipment to send a print job to the print server apparatus via a network; and
a data server, in which a print data file corresponding to the print job is stored, the print server apparatus, the communication terminal equipment and the data server being connected via the network with each other,
wherein when the print job sent by the communication terminal equipment includes a file specifying information to specify a whereabouts of the print data file, and does not comprise the print data file, the print server apparatus, which receives the print job, loads the print data file from the data server based on the file specifying information by the print job acquiring section, identifies a data form of the acquired print data file by the file format identifying section, converts the identified data form of the print data file into a data form of an image data for conducting a printing process, forms an image based on the image data by the image forming section, and outputs the image onto a recording material by the image forming section.

8. A network print system comprising:
the print server apparatus of claim 3;
a communication terminal equipment being to send a print job to the print server apparatus via a network, the communication terminal equipment having a Web browser function and not having a function to form the print job; and
a data server, in which a print data file corresponding to the print job is stored, the print server apparatus the communication terminal equipment and the data server being connected via the network with each other,
wherein when the print job sent by the communication terminal equipment is formed by utilizing a print job forming Web data, and when the print job includes a file specifying information to specify a whereabouts of the print data file, and does not comprise the print data file, the print server apparatus, which receives the print job, loads the print data file from the data server based on the file specifying information by the print job acquiring section, identifies a data form of the acquired print data file by the file format identifying section, converts the identified data form of the print data file into a data form of an image data for conducting a printing process, forms an image based on the image data by the image forming section, and outputs the image onto a recording material by the image forming section.

9. The network print system of claim 8, wherein the communication terminal equipment is selected form the group consisting of a cellphone, a TV set, a car navigation apparatus and a game machine.

10. The network print system comprising:
the print server apparatus of claim 1;
a communication terminal equipment to send an E-mail comprising an attached file including a print job including a print data file; and
a data server having a mail server function to send-and-receive E-mails via a network, and to store the E-mails therein, the print server apparatus, the communication terminal equipment and the data server being connected via the network with each other,
wherein when the E-mail comprising the attached file including the print job including the print data file is transmitted to the print server apparatus from the data server, the print server apparatus, which receives the print job, identifies a data form of the print data file in the print job by the file format identifying section, converts the identified data form of the print data file into a data form of an image data for conducting a printing process, forms an image based on the image data by the image forming section, and outputs the image onto a recording material by the image forming section.

11. A network print system comprising:
the print server apparatus of claim 1,
a communication terminal equipment to send a print job to the print server apparatus via a network, the communication terminal equipment having a Web browser function and not having a function to form the print job; and
a data server, in which a print data file corresponding to the print job and a print job forming Web data are stored, the print server apparatus, the communication terminal equipment and the data server being connected via the network with each other,
wherein when the print job sent by the communication terminal equipment is formed by utilizing the print job forming Web data in the data server, and when the print job includes a file specifying information to specify a whereabouts of the print data file, and does not comprise the print data file, the print server apparatus, which receives the print job, loads the print data file form the data server based on the file specifying information by the print job acquiring section, identifies a data form of the acquired print data file by the file format identifying section, converts the identified data form of the print data file into a data form of an image data for conducting a printing process, forms an image based on the image data by the image forming section, and outputs the image onto a recording material by the image forming section.

12. The network print system of claim 6, wherein the data form converting section comprises a PDL processing section to converting the data form of the print data file into a PDL form, and a print image data forming section to convert the PDL form into the data form of the image data.

13. The network print system of claim 7, wherein the data form converting section comprises a PDL processing section to converting the data form of the print data file into a PDL form, and a print image data forming section to convert the PDL form into the data form of the image data.

14. The network print system of claim 8, wherein the data form converting section comprises a PDL processing section to converting the data form of the print data file into a PDL form, and a print image data forming section to convert the PDL form into the data form of the image data.

15. The network print system of claim 10, wherein the data form converting section comprises a PDL processing section to converting the data form of the print data file into a PDL form, and a print image data forming section to convert the PDL form into the data form of the image data.

16. The network print system of claim 11, wherein the data form converting section comprises a PDL processing section to converting the data form of the print data file into a PDL form, and a print image data forming section to convert the PDL form into the data form of the image data.

17. The network print system of claim 6, wherein the network print system further comprises a data server having therein an application software being capable of converting the data form of the print data file, and the application software is utilized to converting the data form of the print data file.

18. The network print system of claim 7, wherein the data server comprises an application software being capable of converting the data form of the print data file, and the application software is utilized to converting the data form of the print data file.

19. The network print system of claim 8, wherein the data server comprises an application software being capable of converting the data form of the print data file, and the application software is utilized to converting the data form of the print data file.

20. The network print system of claim 10, wherein the data server comprises an application software being capable of converting the data form of the print data file, and the application software is utilized to converting the data form of the print data file.

21. The network print system of claim 11, wherein the data server comprises an application software being capable of converting the data form of the print data file, and the application software is utilized to converting the data form of the print data file.
